(19) United States
(12) Patent Application Publication
(10) Pub. No.: US 2017/0043236 A1
(43) Pub. Date: Feb. 16, 2017

(54) METHOD AND APPARATUS FOR RECOMMENDING MUSIC, AND BICYCLE

(71) Applicants: LE HOLDINGS (BEIJING) CO., LTD., Beijing (CN); LETV SPORTS CULTURE DEVELOP (BEIJING) CO., LTD., Beijing (CN)

(72) Inventor: Dalong LI, Beijing (CN)

(21) Appl. No.: 15/245,232

(22) Filed: Aug. 24, 2016

Related U.S. Application Data
(63) Continuation of application No. PCT/CN2016/081907, filed on May 12, 2016.

(30) Foreign Application Priority Data
Aug. 11, 2015 (CN) 201510491088.6

(51) Int. Cl. A63B 71/06; A63B 24/00; G06F 17/30; A63B 22/06

(52) U.S. Cl. CPC A63B 71/0622; A63B 22/0605; A63B 24/0062; A63B 71/0686; G06F 17/30743; A63B 2071/0625; G10H 2210/076

(57) ABSTRACT

Embodiments of the disclosure provide a method and apparatus for recommending music, and a bicycle, the method including: acquiring a cadence of a sporting user; determining a number of beats corresponding to the acquired cadence according to the cadence, and a preset correspondence relationship between the cadence and the number of beats; and recommending music agreeing with the number of beats for the sporting user according to the number of beats, so that the sporting user can be provided with the music agreeing with his or her sporting state so as to better satisfy the user and to improve the experience of the user.

### CROSS REFERENCE TO RELATED APPLICATIONS

The present disclosure is a continuation of International Application No. PCT/CN2016/081907, filed on May 12, 2016, which is based upon and claims priority to Chinese Patent Application No. 201510491088.6, filed on Aug. 11, 2015, the entire contents of which are incorporated herein by reference.

### TECHNICAL FIELD

Embodiments of the present disclosure relate to the field of manufacturing a bicycle, and particularly to a method and apparatus for recommending music, and a bicycle.

### BACKGROUND

At present, bicycling has become increasingly popular as a low-carbon, environment-conserving, and healthy sporting and traveling mode. Many bicycling users prefer to listen to music and a radio station, or prefer other entertainment means to make their bicycling more joyful.

At present, people typically listen to music and a radio station on their MP3 players or mobile phones, where they listen to random music which may not agree with their current bicycling speeds, thus discouraging their bicycling. For example, if they ride quickly but listen to slowly rhythmic music, or they ride slowly but listen to quickly rhythmic music, then the riders may be depressed, thus discouraging their bicycling.

In view of this, it is highly desirable in the industry to recommend appropriate music for a riding user.

### SUMMARY

Embodiments of the disclosure provide a method and apparatus for recommending music, and a bicycle so as to address the drawback in the prior art of failing to recommend appropriate music for a user while the user is sporting, thus satisfying the user, and improving the experience of the user.

An embodiment of the disclosure provides a method for recommending music, the method including:

at a bicycle,

acquiring a cadence of a sporting user;

determining a number of beats corresponding to the acquired cadence according to the cadence, and a preset correspondence relationship between the cadence and the number of beats; and

recommending, by a bicycle, music agreeing with the number of beats for the sporting user according to the number of beats.

An embodiment of the disclosure provides an apparatus for recommending music, the apparatus including:

at least one processor; and

a memory communicably connected with the at least one processor for storing instructions executable by the at least one processor, wherein execution of the instructions by the at least one processor causes the at least one processor to:

acquire a cadence of a sporting user;

determine a number of beats corresponding to the cadence according to the cadence acquired by the cadence acquiring unit, and a preset correspondence relationship between the cadence and the number of beats; and

recommend music agreeing with the number of beats for the sporting user according to the number of beats determined by the number of beats determining unit.

An embodiment of the disclosure provides a bicycle including a cadence sensor and a processor, wherein:

the cadence sensor is configured to acquire a cadence of a sporting user; and

the processor is configured to obtain the acquired cadence from the cadence sensor, and to determine a number of beats corresponding to the cadence according to the cadence, and a preset correspondence relationship between the cadence and the number of beats; and to recommend music agreeing with the number of beats for the sporting user according to the number of beats.

In the method and apparatus for recommending music, and the bicycle according to the embodiments of the disclosure, the cadence of the sporting user can be acquired, the number of beats corresponding to the acquired cadence can be determined according to the cadence, and the preset correspondence relationship between the cadence and the number of beats, and further the music agreeing with the determined number of beats can be recommended to the sporting user according to the determined number of beats, to thereby recommend the appropriate music for the user while the user is sporting so that the sporting user can be provided with the music agreeing with his or her sporting state so as to better satisfy the user and to improve the experience of the user.

### BRIEF DESCRIPTION OF THE DRAWINGS

One or more embodiments are illustrated by way of example, and not by limitation, in the figures of the accompanying drawings, wherein elements having the same reference numeral designations represent like elements throughout. The drawings are not to scale, unless otherwise disclosed.

FIG. 1 is a flow chart of a method for recommending music according to some embodiments;

FIG. 2 is a flow chart of determining music appropriate for the determined number of beats for a sporting user according to the determined number of beats according to some embodiments;

FIG. 3 is a flow chart of a method for recommending music for a sporting user according to some embodiments;

FIG. 4A is a schematic structural diagram of an apparatus for recommending music according to some embodiments;

FIG. 4B is a schematic structural diagram of another apparatus for recommending music according to some embodiments;

FIG. 5 is a schematic structural diagram of an apparatus for recommending music according to some embodiments;

FIG. 6A is a schematic structural diagram of a bicycle according to some embodiments; and

FIG. 6B is a schematic structural diagram of another bicycle according to some embodiments.

### DETAILED DESCRIPTION

In order to make the objects, technical solutions, and advantages of the embodiments of the disclosure more apparent, the technical solutions according to the embodiments of the disclosure will be described below clearly and fully with reference to the drawings in the embodiments of the disclosure, and apparently the embodiments described below are only a part but not all of the embodiments of the disclosure. Based upon the embodiments here of the disclosure, all the other embodiments which can occur to those skilled in the art without any inventive effort shall fall into the scope of the disclosure.

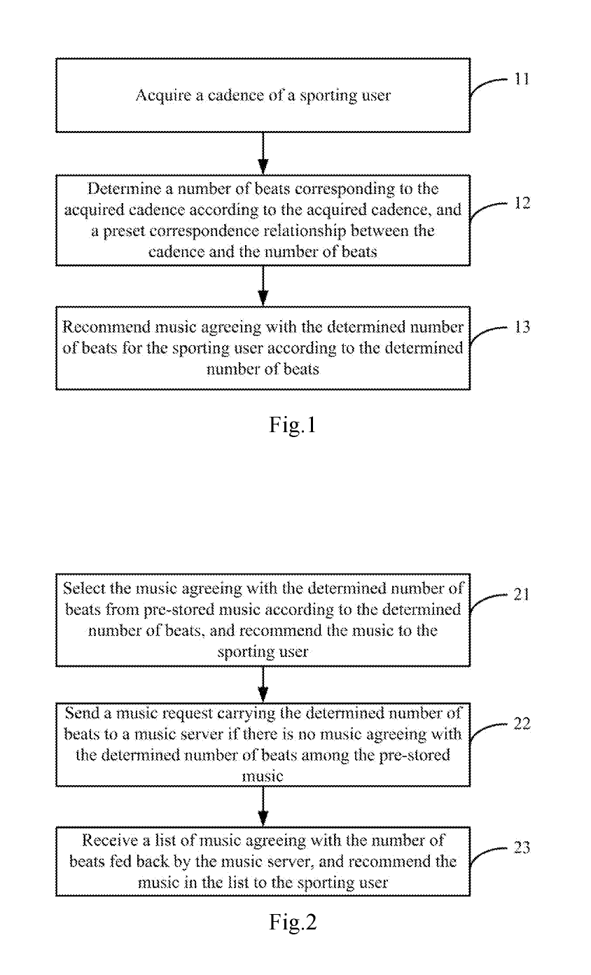

Referring to FIG. 1, an embodiment of the disclosure provides a method for recommending music in the following particular flow:

The step 11 is to acquire a cadence of a sporting user.

“Sporting” as referred to in the embodiment of the disclosure can refer to running or bike riding or any other sporting for which a cadence of a user can be acquired by a cadence sensor.

Here the cadence refers to a frequency at which feet move in a period of time, typically in minute. The cadence (also referred to as a stride frequency) in running represents the number of times that the feet contact the ground per second, and the cadence in bicycling refers to a frequency at which pedals rotate around an axis, also possibly in minute.

In an embodiment, the cadence of the sporting user can be acquired by a cadence sensor. Taking bicycling as an example, the cadence sensor is typically installed on a crank of a bicycle, where the crank is a component configured to connect pedals with a chain ring, and the cadence sensor can detect the frequency at which the pedals rotate around the axis while the crank is rotating.

Here the cadence sensor in an embodiment of the disclosure can include but will not be limited to a Hall sensor.

Particularly the step 11 can be performed as follows without any limitation thereto:

A cadence of the user in a preset length of time is acquired;

The average cadence of the user is determined according to the cadences of the user in a number N of consecutive preset lengths of time, where N represent a positive integer; and

The average cadence of the user is determined as the cadence of the user.

For example, if the preset length of time is 1 minute, and N is 5, then a cadence of the user in each of 5 minutes may be acquired by the cadence sensor, and then the cadence in each minute of the 5 minutes can be summed up and further averaged, where the average thereof is the cadence of the user.

The step 12 is to determine a number of beats corresponding to the acquired cadence according to the acquired cadence, and a preset correspondence relationship between the cadence and the number of beats.

Firstly a beat will be described in brief:

Music is divided into uniform elementary units in time, each of which is referred to a “beat”. The duration of the beat is represented as a note duration, where the duration of a beat can be a ¼ note (that is, a ¼ note is a beat), or ½ note (that is, a ½ note is a beat), or ⅛ note (that is, a ⅛ note is a beat). The duration of the beat is a relative time concept, for example, if a specified speed of music is 60 beats per minute, then each beat may last for one second, and a ½ beat may be half a second; if the specified speed is 120 beats per minute, then each beat may last for half a second, and a ½ beat may be a ¼ second; and so on. Given the general duration of a beat, notes with respective durations are tiered with the beat. For example, if a ¼ note is a beat, then a complete note may be 4 beats, a ½ note may be 2 beats, a ⅛ note may be a ½ beat, and a 1/16 note may be a ¼ beat; and if a ⅛ note is a beat, then a complete note may be 8 beats, a ½ note may be 4 beats, a ¼ note may be 2 beats, and a 1/16 note may be a ½ beat.

As can be known from the description above, the preset correspondence relationship between the cadence and the number of beats in the embodiment of the disclosure can be a 1:1 correspondence relationship, that is, if the acquired cadence is 1, then the corresponding number of beats will also be 1, and if the acquired cadence is 120, then the corresponding number of beats will also be 120.

The step 13 is to recommend music agreeing with the determined number of beats for the sporting user according to the determined number of beats.

Particularly the step 13 can be performed in the flow as illustrated in FIG. 2, particularly as follows:

The step 21 is to select the music agreeing with the determined number of beats from pre-stored music according to the determined number of beats, and to recommend the music to the sporting user.

Particularly firstly beat information of the pre-stored music is retrieved, where the time unit of the number of beats indicated by the beat information is the same as the time unit of the acquired cadence.

For example, if the time unit of the acquired cadence is in minute, then the time unit of the number of beats indicated by the beat information can be also in minute.

Typically the beat information of the music represents Beat Per Minute (BPM) information, where the number of beats of each piece of music is preset when the music is composed and will not vary, and the BPM information thereof can be retrieved from attribute information of the music.

Then the music with the beat information indicating the number of beats matching the determined number of beats is selected from the pre-stored music according to the determined number of beats, and the beat information of the pre-stored music, and the selected music is recommended to the sporting user.

“Matching” in the embodiment of the disclosure can refer to that the number of beats indicated by the beat information exactly matches the determined number of beats, or can refer to that the difference between the number of beats indicated by the beat information, and the determined number of beats lies in a preset threshold range, which is the interval of [−10, 10], for example.

The step 22 is to send a music request carrying the determined number of beats to a music server if there is no music agreeing with the determined number of beats among the pre-stored music.

The step 23 is to receive a list of music agreeing with the number of beats fed back by the music server, and to recommend the music in the list to the sporting user.

As can be apparent from the flow above, in the embodiment of the disclosure, the music agreeing with the determined number of beats can be recommended to the sporting user according to the determined number of beats by firstly selecting the appropriate music from the local music, and then requesting for appropriate music remotely from the music server if there is no appropriate music among the local music.

Here the determined music can be recommended to the user by playing the determined music in a preset playing mode.

Here if the determined music is music in the list of music fed back by the music server, then the music in the list may be firstly downloaded locally, and then played in the preset playing mode; or the music server can be connected, and the music in the list can be played online.

In the embodiment of the disclosure, the cadence of the sporting user can be acquired, the number of beats corresponding to the acquired cadence can be determined according to the cadence, and the preset correspondence relationship between the cadence and the number of beats, and further the music agreeing with the determined number of beats can be recommended to the sporting user according to the determined number of beats, to thereby recommend the appropriate music for the user while the user is sporting so that the sporting user can be provided with the music agreeing with his or her sporting state so as to better satisfy the user and to improve the experience of the user.

In order to better understand the embodiment of the disclosure, a particular implementation of the embodiment of the disclosure will be described below.

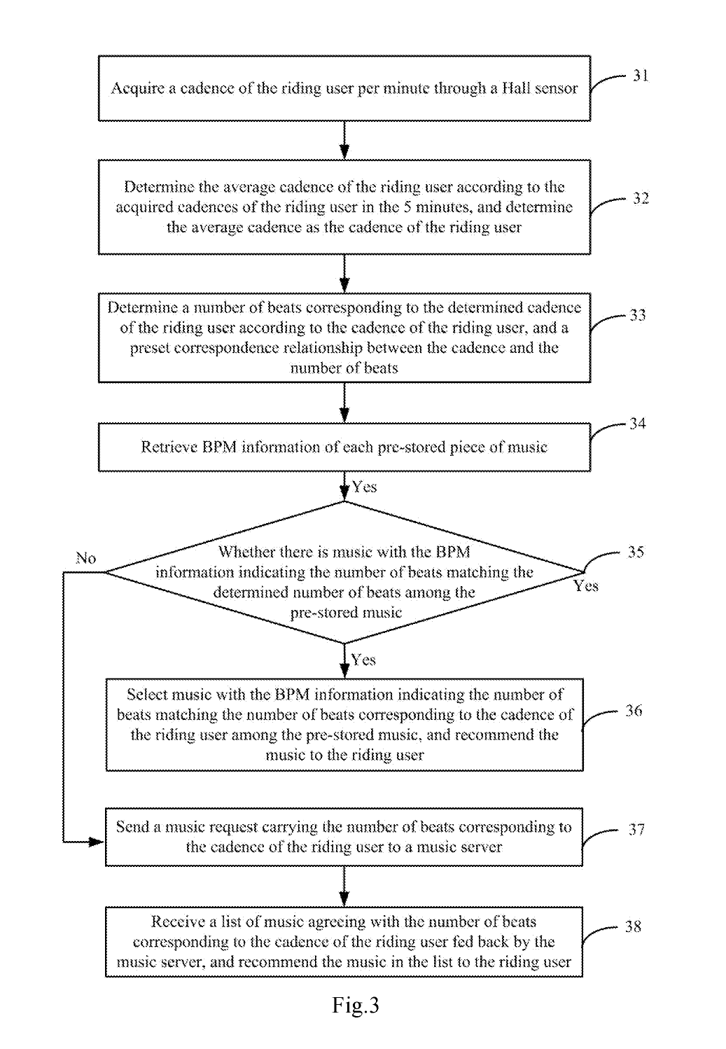

Referring to FIG. 3, there is illustrated a flow chart of a method for recommending music for a bicycling user according to an embodiment of the disclosure, where a preset length of time is 1 minute, and N is 5. The method particularly includes the following steps:

The step 31 is to acquire a cadence of the riding user per minute through a Hall sensor.

Particularly the Hall sensor acquires the frequency at which pedals of a bicycle rotate around an axis per minute.

The step 32 is to determine the average cadence of the riding user according to the acquired cadences of the riding user in the 5 consecutive minutes, and to determine the average cadence as the cadence of the riding user.

The step 33 is to determine a number of beats corresponding to the determined cadence of the riding user according to the cadence of the riding user, and a preset correspondence relationship between the cadence and the number of beats.

The step 34 is to retrieve BPM information of pre-stored music.

The step 35 is to determine whether there is music with the BPM information indicating the number of beats matching the determined number of beats corresponding to the cadence of the riding user among the pre-stored music according to the determined number of beats corresponding to the cadence of the riding user, and the BPM information of the pre-stored music;

If so, then the flow will proceed to the step 36; otherwise, the flow will proceed to the step 37.

The step 36 is to select music with the BPM information indicating the number of beats matching the number of beats corresponding to the cadence of the riding user among the pre-stored music, and to recommend the selected music to the riding user, and the flow is terminated.

The step 37 is to send a music request carrying the number of beats corresponding to the cadence of the riding user to a music server.

The step 38 is to receive a list of music agreeing with the number of beats corresponding to the cadence of the riding user fed back by the music server, and to recommend the music in the list to the riding user.

In the embodiment of the disclosure, the cadence of the riding user can be acquired, the number of beats corresponding to the acquired cadence can be determined according to the cadence, and the preset correspondence relationship between the cadence and the number of beats, and further the music agreeing with the determined number of beats can be recommended to the riding user according to the determined number of beats, to thereby recommend the appropriate music to the user while the user is riding bicycle so that the riding user can be provided with the music agreeing with his or her sporting state so as to better satisfy the user and to improve the experience of the user.

Based upon the same inventive idea, an embodiment of the disclosure further provides an apparatus for recommending music, and a bicycle, and since the apparatus for recommending music, and the bicycle address the problem under a similar principle to the method for recommending music, reference can be made to the implementation of the method for implementations of the apparatus for recommending music, and the bicycle address, so a repeated description thereof will be omitted here.

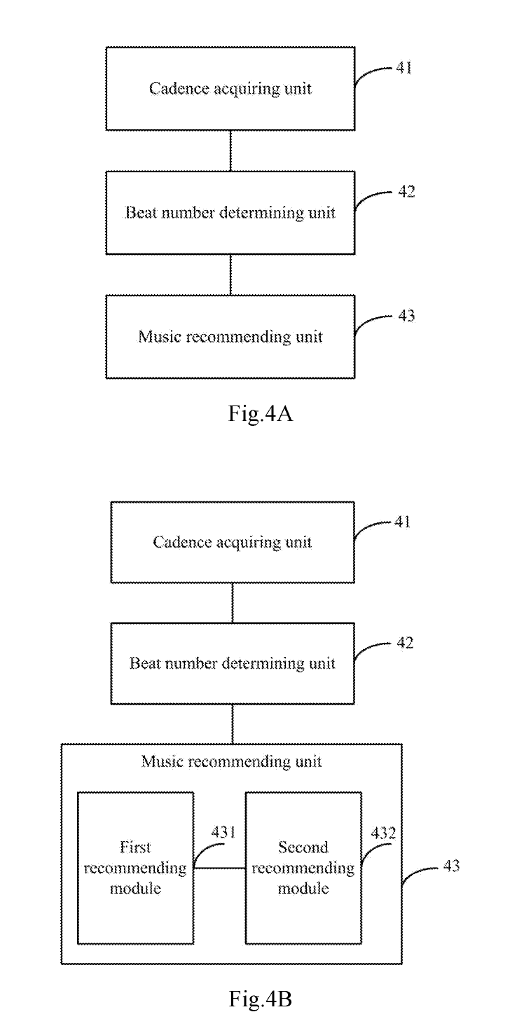

Referring to FIG. 4A, an embodiment of the disclosure provides an apparatus for recommending music, which includes a cadence acquiring unit 41, a beat number determining unit 42, and a music recommending unit 43, all of which can be embodied by a hardware processor, where:

The cadence acquiring unit 41 is configured to acquire a cadence of a sporting user;

The beat number determining unit 42 is configured to determine a number of beats corresponding to the acquired cadence according to the cadence acquired by the cadence acquiring unit 41, and a preset correspondence relationship between the cadence and the number of beats; and

The music recommending unit 43 is configured to recommend music agreeing with the number of beats for the sporting user according to the number of beats determined by the beat number determining unit 42.

Particularly the cadence acquiring unit 41 is configured:

To acquire a cadence of the sporting user in a preset length of time; and to determine the average cadence of the sporting user according to the cadences of the sporting user in a number N of consecutive preset lengths of time, and to determine the average cadence as the cadence of the user, where N represent a positive integer.

Optionally the music recommending unit in the apparatus can be further configured to firstly select appropriate music from local music, and then request appropriate music remotely from a music server if there is no appropriate music among the local music. Particularly referring to FIG. 4B illustrating another apparatus for recommending music according to an embodiment of the disclosure, the apparatus includes:

A cadence acquiring unit 41, a beat number determining unit 42, and a music recommending unit 43.

Where the cadence acquiring unit 41, and the beat number determining unit 42 are substantially the same as in FIG. 4A.

The music recommending unit 43 can particularly include:

A first recommending module 431 configured to select music agreeing with the number of beats from pre-stored music according to the number of beats, and to recommend the music to the sporting user; and

A second recommending module 432 configured to send a music request carrying the determined number of beats to a music server if the first recommending module 431 fails to select music agreeing with the number of beats from the pre-stored music; and to receive a list of music agreeing with the number of beats fed back by the music server, and to recommend the music in the list to the sporting user.

Where the first recommending module 431 is configured:

To retrieve beat information of the pre-stored music, where the time unit of the number of beats indicated by the beat information is the same as the time unit of the cadence; and to select music with the beat information indicating the number of beats matching the number of beats from the pre-stored music according to the number of beats, and the beat information of the pre-stored music, and to recommend the music to the sporting user.

In summary, in the embodiments of the disclosure, the cadence of the sporting user can be acquired, the number of beats corresponding to the acquired cadence can be determined according to the cadence, and the preset correspondence relationship between the cadence and the number of beats, and further the music agreeing with the determined number of beats can be recommended to the sporting user according to the determined number of beats, to thereby recommend the appropriate music for the user while the user is sporting so that the sporting user can be provided with the music agreeing with his or her sporting state so as to better satisfy the user and to improve the experience of the user.

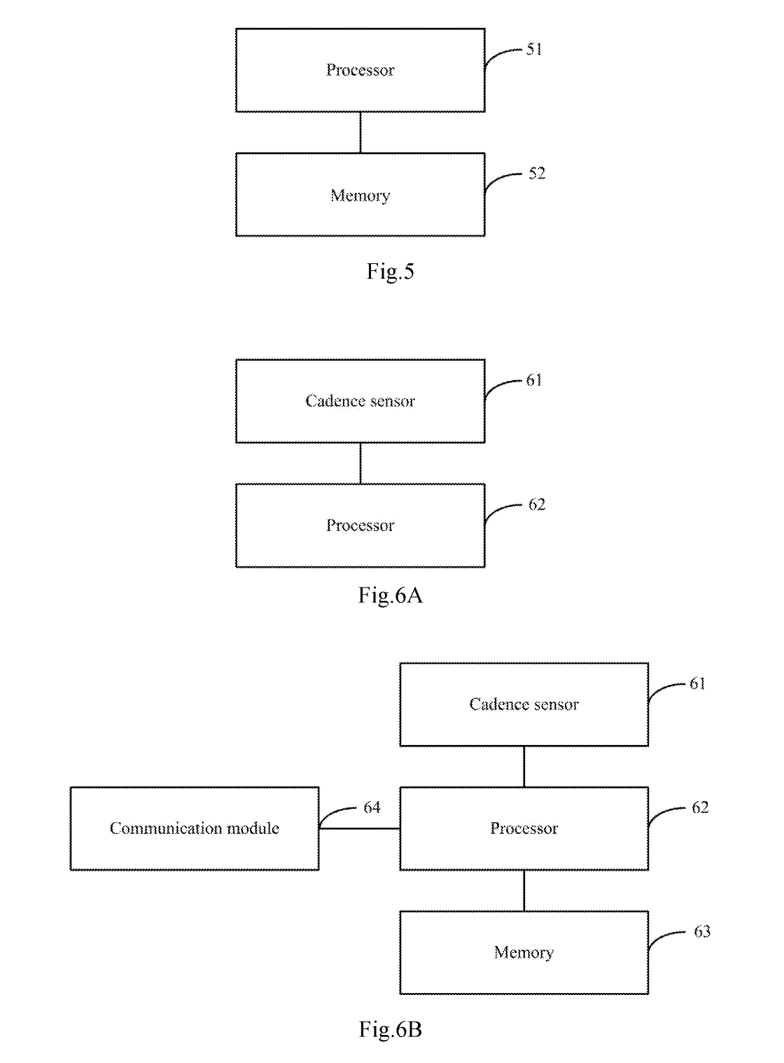

FIG. 5 illustrates a schematic structural diagram of an apparatus for recommending music in accordance with some embodiments, wherein the electronic device includes:

at least one processor 51; and

a memory 52 communicably connected with the at least one processor for storing instructions executable by the at least one processor, wherein execution of the instructions by the at least one processor causes the at least one processor to:

acquire a cadence of a sporting user;

determine a number of beats corresponding to the cadence according to the cadence acquired by the cadence acquiring unit, and a preset correspondence relationship between the cadence and the number of beats; and recommend music agreeing with the number of beats for the sporting user according to the number of beats.

In some embodiments, the acquire a cadence of a sporting user includes:

acquire a cadence of the sporting user in a preset length of time; and determine the average cadence of the sporting user according to the cadences of the sporting user in a number N of consecutive preset lengths of time, and determine the average cadence as the cadence of the user, wherein N represent a positive integer.

In some embodiments, the recommend music agreeing with the number of beats for the sporting user according to the number of beats includes:

select music agreeing with the number of beats from pre-stored music according to the number of beats, and recommend the music to the sporting user; and

send a music request carrying the determined number of beats to a music server if there is no music agreeing with the number of beats among the pre-stored music; and receive a list of music agreeing with the number of beats fed back by the music server, and recommend the music in the list to the sporting user.

In some embodiments, the select music agreeing with the number of beats from pre-stored music according to the number of beats, and recommend the music to the sporting user includes:

retrieve beat information of the pre-stored music, wherein a time unit of the number of beats indicated by the beat information is the same as the time unit of the cadence; and select music with the beat information indicating the number of beats matching the number of beats from the pre-stored music according to the number of beats, and the beat information of the pre-stored music, and recommend the music to the sporting user.

Referring to FIG. 6A, an embodiment of the disclosure provides a bicycle including a cadence sensor 61 and a processor 62, both of which can be embodied by a hardware processor, where:

The cadence sensor 61 is configured to acquire a cadence of a sporting user; and

The processor 62 is configured to obtain the cadence acquired by the cadence sensor 61, and to determine a number of beats corresponding to the cadence according to the cadence, and a preset correspondence relationship between the cadence and the number of beats; and to recommend music agreeing with the number of beats for the sporting user according to the number of beats.

Optionally the cadence sensor 61 is configured:

To acquire a cadence of the sporting user in a preset length of time; and

The processor 62 is configured:

To obtain the cadences of the sporting user in a number N of consecutive preset lengths of time from the cadence sensor 61, to determine the average cadence of the sporting user according to the obtained cadences, and to determine the average cadence as the cadence of the sporting user, where N represent a positive integer.

Optionally the bicycle can be provided with a communication function so that the music can be recommended to the sporting user by firstly selecting appropriate music from local music, and then requesting appropriate music remotely from a music server through the communication function thereof if there is no appropriate music among the local music. Particularly referring to FIG. 6B illustrating another bicycle according to an embodiment of the disclosure, the bicycle includes:

A cadence sensor 61, a processor 62, a memory 63, and a communication module 64.

Where the cadence sensor 61 and the processor 62 are substantially the same as in FIG. 6A.

The memory 63 is configured to pre-store music, and beat information of each piece of music; and

The processor 62 is configured:

To select music agreeing with the number of beats from the pre-stored music according to the number of beats, and to recommend the music to the sporting user; to send a music request carrying the number of beats to a music server through the communication module 64 if the processor fails to select music agreeing with the number of beats from the pre-stored music; and to receive a list of music agreeing with the number of beats fed back by the music server through the communication module 64, and to recommend the music in the list to the sporting user.

Where the communication module 64 can include a Third-Generation (3G) or Fourth-Generation (4G) mobile communication Subscriber Identity Module (SIM) card, a signal transceiver, and peripheral circuits, etc.

The embodiments of the apparatus described above are merely exemplary, where the units described as separate components may or may not be physically separate, and the components illustrated as elements may or may not be physical units, that is, they can be collocated or can be distributed onto a number of network elements. A part or all of the modules can be selected as needed in reality for the purpose of the solution according to the embodiments of the disclosure. This can be understood and practiced by those ordinarily skilled in the art without any inventive effort.

Those skilled in the art can clearly appreciate from the foregoing description of the embodiments that the embodiments of the disclosure can be implemented in hardware or in software plus a necessary general hardware platform. Based upon such understanding, the technical solutions above essentially or their parts contributing to the prior art can be embodied in the form of a computer software product which can be stored in a computer readable storage medium, e.g., an ROM/RAM, a magnetic disk, an optical disk, etc., and which includes several instructions to cause a computer device (e.g., a personal computer, a server, a network device, etc.) to perform the method according to the respective embodiments of the disclosure.

Lastly it shall be noted that the respective embodiments above are merely intended to illustrate but not to limit the technical solution of the disclosure; and although the disclosure has been described above in details with reference to the embodiments above, those ordinarily skilled in the art shall appreciate that they can modify the technical solution recited in the respective embodiments above or make equivalent substitutions to a part of the technical features thereof; and these modifications or substitutions to the corresponding technical solution shall also fall into the scope of the disclosure as claimed.

What is claimed is:

1. A method for recommending music, the method comprising:
at a bicycle,
acquiring a cadence of a sporting user;
determining a number of beats corresponding to the acquired cadence according to the cadence, and a preset correspondence relationship between the cadence and the number of beats; and
recommending music agreeing with the number of beats for the sporting user according to the number of beats.

2. The method according to claim 1, wherein acquiring the cadence of the sporting user comprises:
acquiring the cadence of the sporting user through a cadence sensor.

3. The method according to claim 1, wherein acquiring the cadence of the sporting user comprises:
acquiring a cadence of the sporting user in a preset length of time; and
determining an average cadence of the sporting user according to the cadences of the sporting user in a number N of consecutive preset lengths of time, and determining the average cadence as the cadence of the user, wherein N represent a positive integer.

4. The method according to claim 1, wherein recommending the music agreeing with the number of beats for the sporting user according to the number of beats comprises:
selecting music agreeing with the number of beats from pre-stored music according to the number of beats, and recommending the music to the sporting user;
sending a music request carrying the determined number of beats to a music server if there is no music agreeing with the number of beats among the pre-stored music; and
receiving a list of music agreeing with the number of beats fed back by the music server, and recommending the music in the list to the sporting user.

5. The method according to claim 2, wherein recommending the music agreeing with the number of beats for the sporting user according to the number of beats comprises:
selecting music agreeing with the number of beats from pre-stored music according to the number of beats, and recommending the music to the sporting user;
sending a music request carrying the determined number of beats to a music server if there is no music agreeing with the number of beats among the pre-stored music; and
receiving a list of music agreeing with the number of beats fed back by the music server, and recommending the music in the list to the sporting user.

6. The method according to claim 3, wherein recommending the music agreeing with the number of beats for the sporting user according to the number of beats comprises:
selecting music agreeing with the number of beats from pre-stored music according to the number of beats, and recommending the music to the sporting user;
sending a music request carrying the determined number of beats to a music server if there is no music agreeing with the number of beats among the pre-stored music; and
receiving a list of music agreeing with the number of beats fed back by the music server, and recommending the music in the list to the sporting user.

7. The method according to claim 4, wherein selecting the music agreeing with the number of beats from pre-stored music according to the number of beats, and recommending the music to the sporting user comprises:
retrieving beat information of the pre-stored music, wherein a time unit of the number of beats indicated by the beat information is the same as the time unit of the cadence; and
selecting music with the beat information indicating the number of beats matching the number of beats from the pre-stored music according to the number of beats, and the beat information of the pre-stored music, and recommending the music to the sporting user.

8. An apparatus for recommending music, the apparatus comprising:
at least one processor; and
a memory communicably connected with the at least one processor for storing instructions executable by the at least one processor, wherein execution of the instructions by the at least one processor causes the at least one processor to:
acquire a cadence of a sporting user;
determine a number of beats corresponding to the cadence according to the cadence acquired by the cadence acquiring unit, and a preset correspondence relationship between the cadence and the number of beats; and
recommend music agreeing with the number of beats for the sporting user according to the number of beats.

9. The apparatus according to claim 8, wherein acquire a cadence of a sporting user comprises:
acquire a cadence of the sporting user in a preset length of time; and determine the average cadence of the sporting user according to the cadences of the sporting user in a number N of consecutive preset lengths of time, and determine the average cadence as the cadence of the user, wherein N represent a positive integer.

10. The apparatus according to claim 8, wherein recommend music agreeing with the number of beats for the sporting user according to the number of beats comprises:
select music agreeing with the number of beats from pre-stored music according to the number of beats, and recommend the music to the sporting user; and
send a music request carrying the determined number of beats to a music server if there is no music agreeing with the number of beats among the pre-stored music; and receive a list of music agreeing with the number of beats fed back by the music server, and recommend the music in the list to the sporting user.

11. The apparatus according to claim 9, wherein recommend music agreeing with the number of beats for the sporting user according to the number of beats comprises:
select music agreeing with the number of beats from pre-stored music according to the number of beats, and recommend the music to the sporting user; and
send a music request carrying the determined number of beats to a music server if there is no music agreeing with the number of beats among the pre-stored music; and receive a list of music agreeing with the number of beats fed back by the music server, and recommend the music in the list to the sporting user.

12. The apparatus according to claim 10, wherein select music agreeing with the number of beats from pre-stored music according to the number of beats, and recommend the music to the sporting user comprises:
retrieve beat information of the pre-stored music, wherein a time unit of the number of beats indicated by the beat information is the same as the time unit of the cadence; and select music with the beat information indicating the number of beats matching the number of beats from the pre-stored music according to the number of beats, and the beat information of the pre-stored music, and recommend the music to the sporting user.

13. A bicycle, comprising a cadence sensor and a processor, wherein:
the cadence sensor is configured to acquire a cadence of a sporting user; and
the processor is configured to obtain the acquired cadence from the cadence sensor, and to determine a number of beats corresponding to the cadence according to the cadence, and a preset correspondence relationship between the cadence and the number of beats; and to recommend music agreeing with the number of beats for the sporting user according to the number of beats.

14. The bicycle according to claim 13, wherein the cadence sensor is configured:
to acquire a cadence of the sporting user in a preset length of time; and
the processor is configured:
to obtain the cadences of the sporting user in a number N of consecutive preset lengths of time from the cadence sensor, to determine an average cadence of the sporting user according to the obtained cadences, and to determine the average cadence as the cadence of the sporting user, wherein N represent a positive integer.

15. The bicycle according to claim 13, further comprising a memory and a communication module, wherein:
the memory is configured to pre-store music, and beat information of each piece of music; and
the processor is configured:
to select music agreeing with the number of beats from the pre-stored music according to the number of beats, and to recommend the music to the sporting user; to send a music request carrying the number of beats to a music server through the communication module if the processor fails to select music agreeing with the number of beats from the pre-stored music; and
to receive a list of music agreeing with the number of beats fed back by the music server through the communication module, and to recommend the music in the list to the sporting user.

16. The bicycle according to claim 14, further comprising a memory and a communication module, wherein:
the memory is configured to pre-store music, and beat information of each piece of music; and
the processor is configured:
to select music agreeing with the number of beats from the pre-stored music according to the number of beats, and to recommend the music to the sporting user; to send a music request carrying the number of beats to a music server through the communication module if the processor fails to select music agreeing with the number of beats from the pre-stored music; and to receive a list of music agreeing with the number of beats fed back by the music server through the communication module, and to recommend the music in the list to the sporting user.
